(19) United States
(12) Patent Application Publication
(10) Pub. No.: US 2003/0144748 A1
(43) Pub. Date: Jul. 31, 2003

(54) Apparatus for optimizing combinatorial optimization problems

(75) Inventors: Shizuka Nakamura, Tokyo (JP); Nobuhiko Itaya, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/229,004

(22) Filed: Aug. 28, 2002

(30) Foreign Application Priority Data
Jan. 30, 2002 (JP) 022074-2002

(51) Int. Cl. G05B 13/02

(52) U.S. Cl. 700/28

(57) ABSTRACT

Starting from an initial combination state, a destination state to which a certain state is to be moved is determined from its neighboring states or previously defined transferable combination states by using an evaluation function, and an optimal combination state for minimizing or maximizing the function value of an evaluation function comprising the sum of a function to be minimized or maximized and a penalty function representing an amount of constraint violation is intended to be found by iteratively performing a search in which the certain state is successively moved to the thus determined destination state. It is determined whether there is a constraint violation in the current state. If so, the evaluation function is switched to another evaluation function for evaluating a constraint violation alone, whereas if not, the evaluation function is switched to another evaluation function which disregards the constraint violation.

### BACKGROUND OF THE INVENTION

1. Field of the Invention

The present invention relates to an apparatus for optimizing combinatorial optimization problems using a computer.

2. Description of the Prior Art

As a conventional solution finding method for combinatorial optimization problems, for example, there has been known the one according to a simulated annealing method published in an article entitled “New Power System Planning Technique” of the Institute of Electrical Engineers technical report No.647 (page 51).

This simulated annealing method (Simulated Annealing: SA) proposed by S. Kirkpatrick in the year of 1983 is a method of simulating the annealing process in a physical system. Annealing is a process where a solid material is heated to melt, and then gradually cooled to generate a crystal. When a solid material is heated into a molten state by supplying energy thereto to raise the temperature thereof, particles of the material come to take a random arrangement or configuration. By gradually lowering the temperature from that state, the molten material becomes a ground state of minimum internal energy, and the particles at this time becomes a regular configuration, i.e., a crystal. The SA method makes such a behavior of particles correspond to a decision variable of a combinatorial optimization problem, so that the annealing process can be simulated on a computer.

In a physical system consisting of a lot of particles, the particles, which are in an equilibrium state at a temperature of T, follows a Boltzmann distribution as shown by the following expression.

Pr{E=E}=(1/Z(T))·exp(−E/(K_{B}T))

Here, E is the energy of the system, and K_{B} is Boltzmann's constant. In addition, Z(T) is a normalization factor which depends on the temperature T, and is called a distribution function. The exponential function in the above expression is called the Boltzmann factor. When the temperature of such a system is gradually lowered, the Boltzmann distribution converges to the lowest energy state, and there exists only a configuration of minimum energy with a non-zero probability in the vicinity of a zero temperature.

To simulate the behavior of particles in such a physical system on a computer, N. Metropolis proposed the following procedure. When the current configuration of particles is given, the particles of interest are chosen at random, and a random, minute perturbation is given to the configuration. If a change ΔE in the energy at that time is negative, the energy of the perturbed configuration is smaller than that before the perturbation, and hence this configuration is adopted. If the change ΔE is positive, the configuration after the perturbation is adopted at a probability according to the Boltzmann factor. If the configuration is given by such a perturbation a sufficient number of times, the system becomes equilibrium, and the probability distribution of the energy states of the system gradually approaches the Boltzmann distribution. This rule adopting a new configuration in the above-mentioned manner is called the Metropolis criterion. The procedure of finding the equilibrium of a physical system using the Metropolis criterion is called the Metropolis algorithm.

In order to apply the Metropolis algorithm as a solution finding technique for a combinatorial optimization problem, a configuration of particles in a physical system is made to correspond to a variable x in the combinatorial optimization problem, and the energy E of the physical system is made to correspond to an objective function f(x) in the combinatorial optimization problem. Also, the temperature factor K_{B}T of the physical system is taken as a control parameter, which may sometimes be simply called “temperature” in view of correspondence to the physical system. Thus, K_{B}T is simply denoted hereinafter by T, which is called temperature.

In order to find an optimal solution or a sub-optimal solution through the application of the SA method, it is necessary to lower the temperature slowly while spending a long time. The way to lower the temperature is called the cooling schedule. The accuracy of the solution obtained and the efficiency of computation required depend greatly on what cooling schedule is used. S. Geman et al showed that an optimal solution is obtained at a probability of “1” if the cooling is carried out on the condition that an infinite number of perturbations are given to a configuration at each temperature and that the temperature may meet the requirement of (T>c/log k), where k is the number of times of iterations with respect to the temperature, and c is a constant which does not depend on the temperature. However, such a cooling schedule is not feasible in terms of computing time. Therefore, a fixed rate cooling schedule method is often used in which in actuality, the number of perturbations is limited to a finite value at each temperature, and the temperature is set such that T^{k+1}=ρT^{k}, 0<ρ<1, where ρ is the cooling rate which is usually set to some value satisfying ρ>0.95.

FIG. 7 shows a flow chart of a known solution finding technique for a combinatorial optimization problem according to the above-mentioned simulated annealing method.

In FIG. 7, first in a processing block or step 1, the initial values of x and T, which represent the state of a combination and the temperature of a physical system, respectively, are set. Then, in a processing block or step 2, a neighboring solution y, which is a neighbor or a neighboring state of x, is generated. Thereafter, in a processing block or step 3, an amount of change ΔE of an objective function (evaluation function) for y and x is calculated. If it is determined in a processing block or step 4 that ΔE is negative (e.g., y being a solution better than x), the process is changed or passed to a processing block or step 6, whereas if ΔE is not negative, the process is passed to a processing block or step 5. In the processing block 5, a uniform random number γ in a section [0, 1] is generated, and it is determined whether Exp(−ΔE/T)>γ. If the above inequality holds, the deterioration or worsening of the solution is allowed, and the process is passed to the processing block 6, whereas if the above inequality does not hold, x is not updated and the process is passed to a processing block or step 7. Here, note that the smaller the amount of change ΔE (i.e., the degree of deterioration or worsening of a solution for y being less than that for x), and the higher the temperature T, the greater becomes the probability of the inequality (Exp(−ΔE/T)>γ) holding good. In the processing block 6, x is updated to y (i.e., x is moved to y).

In the processing block 7, it is determined whether the system has reached equilibrium (i.e., this being the state in which there is no change in x even if the above determination is carried out a multitude of times). If equilibrium has not yet been reached, the process is returned to the processing block 2, whereas if equilibrium has been reached, the process is passed to a processing block or step 8 in order to lower the temperature T. In the processing block 8, to lower the temperature T, T is multiplied by ρ (0<ρ<1). Thereafter, in a processing block or step 9, it is determined whether the system has reached a ground state (i.e., a state with a low enough temperature T). If the system is determined to be as a ground state, x at that time is assumed to be the optimal solution, and the process is ended. If otherwise, however, the process is returned to the processing block 2.

According to the above-described method, a transition or move to a worse condition is permitted stochastically, so even if x reaches a local optimal solution, transition or moving is able to be continued without being trapped at a local optimal solution. As a result, it becomes possible to find a better solution.

Thus, the greatest technical difficulty in solving combinatorial optimization problems by using search methods is how to escape from local optimal solutions and to continue searching. A variety of methods have hitherto been proposed to solve such difficulty, and these are roughly classified as follows.

1) A transition or move to a worse condition is permitted at a certain probability (the above-mentioned method).

2) A transition or move to the best condition among permitted transitions or moves is iterated (in this case, there being generated a transition or move in which the value of an evaluation function deteriorates or worsens in terms of a local optimal solution), and for those portions in which there has been made a change in the content of a combination, a reverse change is prohibited for a certain period of time, thereby suppressing a return to the once passed local optimal solution.

3) A transition or move to the best condition among permitted transitions or moves is iterated (in this case, there being generated a transition or move in which the value of an evaluation function deteriorates or worsens in terms of a local optimal solution), and the value of the evaluation function for each passed local optimal solution is worsened so that subsequent evaluations thereof may be made through the use of the thus worsened evaluation function value, thereby suppressing a return to the once passed local optimal solution.

### SUMMARY OF THE INVENTION

The present invention is intended to provide an apparatus for optimizing combinatorial optimization problems by using a computer, in which a novel and efficient method is adopted to cope with how to escape from local optimal solutions to continue searching, which is the greatest technical difficulty in solving the combinatorial optimization problems by using search methods.

According to one aspect, the present invention resides in an apparatus for optimizing combinatorial optimization problems by using a computer, in which starting from an initial combination state, a destination state to which a certain state is to be moved is determined from its neighboring states or previously defined transferable combination states by using an evaluation function, and an optimal combination state for minimizing or maximizing the function value of an evaluation function comprising the sum of a function to be minimized or maximized and a penalty function representing an amount of constraint violation is found by iteratively performing a search in which the certain state is successively moved to the thus determined destination state. When there exists no neighboring state having an evaluation function value better than that of the current combination state, and when there still remains a constraint violation in the current combination state, a first processing part switches the evaluation function to another evaluation function which evaluates a constraint violation alone thereby to find a sub-search initial evaluation function value, which is an evaluation function value for a current combination state. A second processing part starts a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing. When there exists no neighboring state having an evaluation function value better than that of the current combination state, and when there exists no constraint violation in the current combination state, a third processing part switches the evaluation function to another evaluation function which disregards the constraint violation thereby to find a sub-search initial evaluation function value, which is an evaluation function value for the current combination state. A fourth processing part starts a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there no longer exists a better solution, thus ending the processing.

When a local optimal solution is reached in the process of searching, the evaluation function is switched to another evaluation function. Thus, the value of a penalty function representing the amount of constraint violation can be improved though the value of a function constituting the evaluation function to be minimized or maximized may be increased or decreased, or the value of a function to be minimized or maximized, which constitutes the evaluation function, can be decreased or increased though a constraint violation may take place. Accordingly, it becomes possible for a state to move to its neighboring state, which would be difficult in a search using an original or intrinsic evaluation function, thereby enabling an efficient escape from the neighborhood of a local optimal solution. As a result, the efficiency of the entire search can be improved, thus making it possible to solve combinatorial optimization problems in an efficient manner.

Preferably, in the first processing part, the evaluation function comprises a total sum of a function to be minimized or maximized and a plurality of penalty functions each representing the value of each type of constraint violation, and the evaluation function is switched to a total sum of penalty functions corresponding to those types of constraints for which constraint violations still remain, thereby to find a sub-search initial evaluation function value, which is an evaluation function value for the current combination state, when there exists no neighboring state having an evaluation function value better than that of the current combination state, and when there still remain constraint violations in the current combination state.

According to another aspect, when there exists no neighboring state having an evaluation function value better than that of the current combination state, and when there still remains a constraint violation in the current combination state, a first processing part switches the evaluation function to a new evaluation function in which the weights of components other than the penalty function are reduced, thereby to find a sub-search initial evaluation function value, which is an evaluation function value for a current combination state.

Preferably, in the first processing part, the evaluation function comprises a total sum of a function to be minimized or maximized and a plurality of penalty functions each representing the value of each type of constraint violation, and the evaluation function is switched to a new evaluation function in which the weights of components other than penalty functions corresponding to those types of constraints for which constraint violations still remain are reduced, thereby to find a sub-search initial evaluation function value, which is an evaluation function value for the current combination state, when there exists no neighboring state having an evaluation function value better than that of the current combination state, and when there still remain constraint violations in the current combination state.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a block diagram schematically illustrating one example of the construction of a computer which is an apparatus for optimizing combinatorial optimization problems according to the present invention.

FIG. 2 is a flow chart explaining the operation of the apparatus for optimizing combinatorial optimization problems according to one embodiment of the present invention.

FIG. 3 is a view explaining the operational effect of a solution finding technique for combinatorial optimization problems according to the present invention.

FIG. 4 is a flow chart explaining the operation of an apparatus for optimizing combinatorial optimization problems according to another embodiment of the present invention.

FIG. 5 is a flow chart explaining the operation of an apparatus for optimizing combinatorial optimization problems according to a further embodiment of the present invention.

FIG. 6 is a flow chart explaining the operation of an apparatus for optimizing combinatorial optimization problems according to a still further embodiment of the present invention.

FIG. 7 is a flow chart of a known solution finding technique for combinatorial optimization problems according to a simulated annealing method.

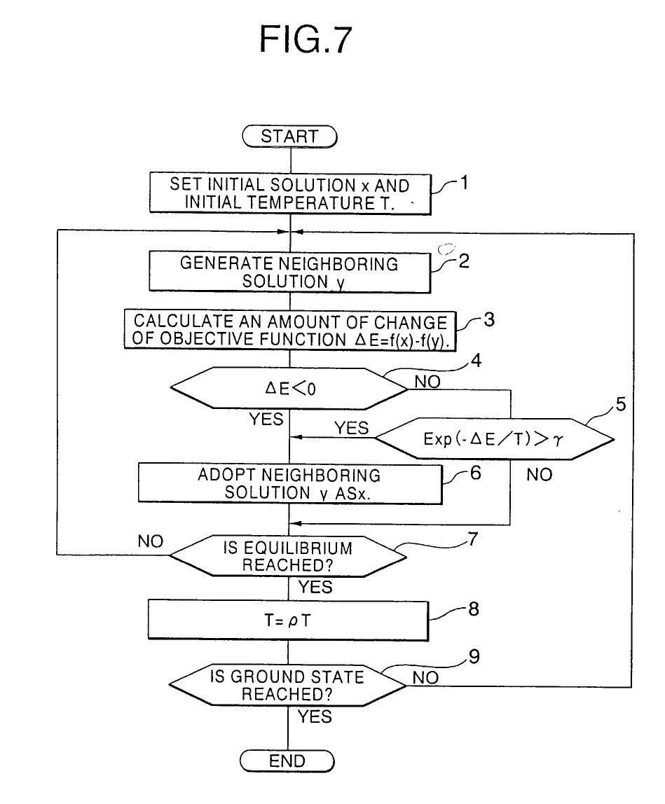

### DESCRIPTION OF THE PREFERRED EMBODIMENTS

Hereinafter, preferred embodiments of the present invention will be described in detail while referring to the accompanying drawings.

Embodiment 1.

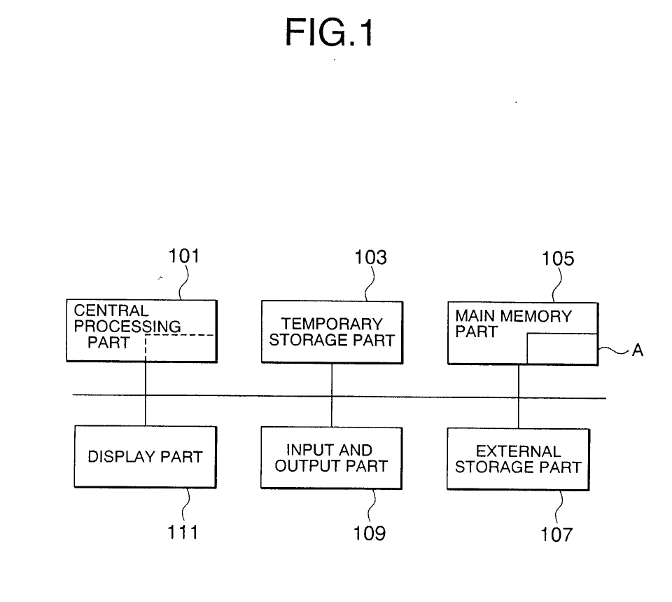

FIG. 1 is a block diagram schematically illustrating one example of the construction of a computer which implements an apparatus for optimizing combinatorial optimization problems according to the present invention. In FIG. 1, a central processing part 101 processes the data stored in a main memory part 105 and performs data transmission between the respective parts of the computer under the control of programs stored in the main memory part 105. A primary storage part 103 is used as a temporary data storage part and the like during the operational processing of the central processing part 101. The main memory part 105 stores programs and data that the central processing part 101 is able to directly deal with. An external storage part 107 stores programs and data to be used thereby (i.e., data unable to be directly dealt with by the central processing part 101). An input and output part 109 functions as an interface for external peripheral equipment and other devices. A reference numeral 111 designates a display part. Here, note that in some case, the primary storage part 103 may be built into the central processing part 101, as shown by the broken line.

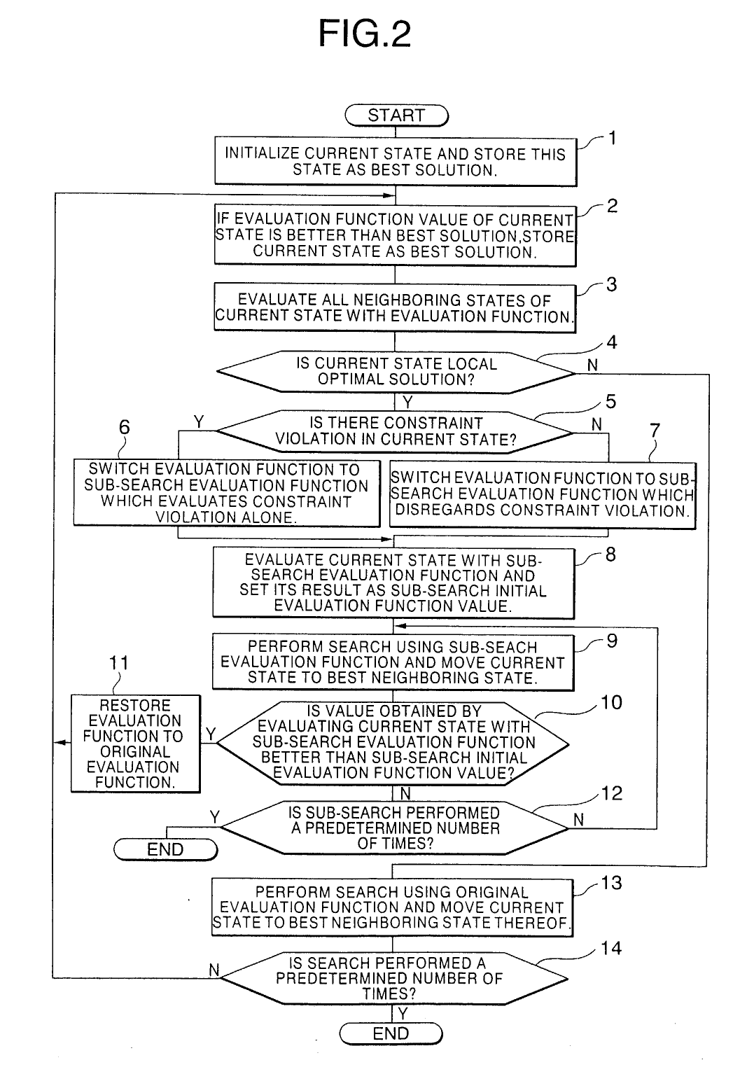

FIG. 2 is a flow chart explaining the operation of the apparatus for optimizing combinatorial optimization problems in accordance with a first embodiment of the present invention. Hereinafter, reference will be made to the operation of this apparatus according to the flow chart of FIG. 2. In FIG. 2, first in a processing block or step 1, the initial state of a system to be optimized is set to the current state which represents the state of a combination at a certain point in time (e.g., at a time at which the apparatus is powered on), and the current state thus set is preserved or stored as the best solution in the temporary storage part 103. Then, in a processing block or step 2, when the value of an evaluation function for the current state is better than that for the best solution stored, the current state is stored in the temporary storage part 103 as the best solution.

A variety of evaluation functions (see A in FIG. 1) are stored in the main memory part 105, and these evaluation functions are used during the processing operation of the central processing part 101. Data such as the value of each evaluation function obtained through processing or temporary data during the processing of arithmetic calculations is stored in the temporary storage part 103, and updated and changed as the processing proceeds. Note that the place where the various evaluation functions and the respective evaluation function values are preserved or stored is not limited to this, and the above-mentioned one is merely one example. In addition, the processes and processing results can be properly displayed at the display part 111 as necessary.

Subsequently, in a processing block or step 3, all the neighboring states of the current state are examined or evaluated by using an evaluation function. In a processing block or step 4, based on the results in the processing block 3, it is determined whether the current state is a local optimal solution (i.e., a state in which there exists no better state among the neighboring states than the current state). If the current state is a local optimal solution, the process is then changed or passed to a processing block or step 5, whereas when the current state is not a local optimal solution, the process is changed or passed to a processing block or step 13.

In the processing block 5, it is determined whether there is a constraint violation in the current state. If a constraint violation exists in the current state, the process is changed or passed to a processing block or step 6, whereas if not, the process is changed or passed to a processing block or step 7. In the processing block 6, the evaluation function is switched to another evaluation function (i.e., an evaluation function for sub-search) for evaluating a constraint violation alone. In the processing block 7, the evaluation function is switched to a further evaluation function (i.e., an evaluation function for sub-search) which disregards a constraint violation.

In a processing block or step 8, the current state is evaluated by using the sub-search evaluation function, and the function value thus obtained is stored as a sub-search initial evaluation function value. In a processing block or step 9, neighboring states of the current state are evaluated by using the sub-search evaluation function, and the current state is changed or moved into the best neighboring state. In a processing block or step 10, it is determined whether the evaluation function value of the current state (i.e., the value obtained by using the sub-search evaluation function) is better than the stored sub-search initial evaluation function value. If it is better, in order to restore the evaluation function to the original or intrinsic evaluation function, the process is changed or passed to a processing block or step 11. If, however, it is not better, the process is changed or passed to a processing block or step 12.

In the processing block 11, the evaluation function is restored to the original evaluation function, and in order to continue the search using the original evaluation function, the process is returned to the processing block 2. In the processing block 12, it is determined whether the sub-search (i.e., a search using the sub-search evaluation function) have been carried out a predetermined number of times. If the predetermined number of sub-searches have been carried out, the process is ended, whereas if not, the process is returned to the processing block 9 and the sub-search is continued.

In the processing block 13, the neighboring states of the current state are evaluated by using the original evaluation function, and the current state is changed or moved into the best neighboring state. In a processing block or step 14, it is determined whether the original search has been carried out a predetermined number of times. If so, the process is ended whereas if not, the process is returned to the processing block 2 and the search is continued.

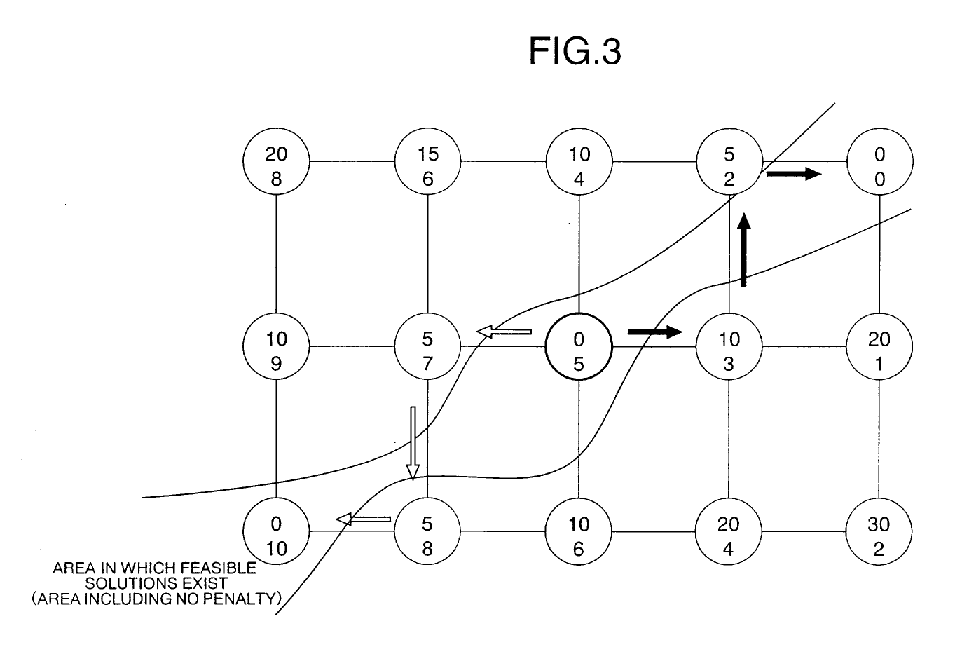

Next, the operational effect of the above-described solution finding technique for combinatorial optimization problems according to the present invention will be explained below while referring to FIG. 3. In FIG. 3, the numerical values on the upper and lower rows in each circle represents a penalty value and the value of an evaluation function to be minimized, respectively. In addition, a white arrow indicates a search route or path according to a known searching method, and a black arrow indicates a search route or path according to the present invention.

Now, it is assumed that the initial state of the system to be optimized is in a state shown by a thick circle. The value of the evaluation function in this state (i.e., the sum of the numerical value on the lower row to be minimized and the numerical value on the upper row representing a penalty) is five, and hence this is in a situation including no constraint violation (i.e., the penalty value being 0). In addition, this state is a local optimal solution which has no better state among its neighboring states (i.e., there being no neighboring state having its evaluation function value less than 5).

In this state, a conventional search (i.e., the method described in 3) in the “Description of the Related Art” section) is made. First, since this state is a local optimal solution, the evaluation function value for this state is increased by a large enough value (for instance, the evaluation function value being added by 100 to provide a new evaluation function value of 105), so that this state is moved to the best state among its neighboring states, that is, the leftside state with its evaluation function value of 12 (i.e., 5+7). This new state also becomes a local optimal solution because the evaluation function value of the right-side state was increased to 105, resulting in the new state becoming a local optimal solution. Thus, the evaluation function value for this state is increased by a large enough value. When the conventional search is further made in this state, the state is moved down to its lower state having an evaluation function value of 13 and thence to its left-side state having an evaluation function value of 10. In this manner, the conventional search gives rise to a problem in that when there is a conflict between a penalty and an evaluation function value to be minimized, the search proceeds in an undesirable direction.

In contrast to this, however, according to the present invention, the initial or central state is a local optimal solution without any constraint violation. Therefore, a sub-search is made while disregarding constraints (penalty values), and advances to its right-side state. This state having a sub-search evaluation function value of 3 is better than the initial state having a sub-search initial evaluation function value of 5. Accordingly, the search is restored to the conventional search, and the state moves up to its upper state having an evaluation function value of 7. (In this case, the state is unable to move to the left because its left-side evaluation function value, which would have an evaluation function value of 5 according to the conventional search, was increased to 105 for instance.) Subsequently, the state moves to its right-side state having an evaluation function value of 0. Thus, according to the present invention, even if there is a conflict between a penalty and an evaluation function value to be minimized, the search is able to move in a desirable direction.

In the above description, there has been explained the operational effect of the present invention in the case where a search is trapped at a local optimal solution having no constraint violation. In the following, however, reference will be made to the effect of the present invention in the case where a search is trapped at a local optimal solution including a constraint violation. FIG. 3 will be used for the following explanation, and to this end, the values on the upper and lower rows in each circle are hereinafter read or changed for an evaluation function value to be minimized and a penalty value, respectively.

The moving of the conventional search is decided solely by the sum of an evaluation function value to be minimized and a penalty value, and hence it is not altered by the above change in reading.

Since the initial or central state is a local optimal solution having a constraint violation according to the present invention, a sub-search is started while disregarding an evaluation function value to be minimized (i.e., numerical value on the upper row), and it advances to its right state. This state having a sub-search evaluation function value of 3 is better than the initial or central state having a sub-search initial evaluation function value of 5. Accordingly, the search is restored to the conventional search, and the state moves to its upper state having an evaluation function value of 7. (In this case, the state is unable to be returned to its left-side state because the evaluation function value of the local optimal solution was sufficiently increased.) Subsequently, the state moves to its right-side state having an evaluation function value of 0. In this manner, according to the present invention, even if there is a conflict between a penalty and a evaluation function value to be minimized, the search is able to move in a desirable direction.

Embodiment 2.

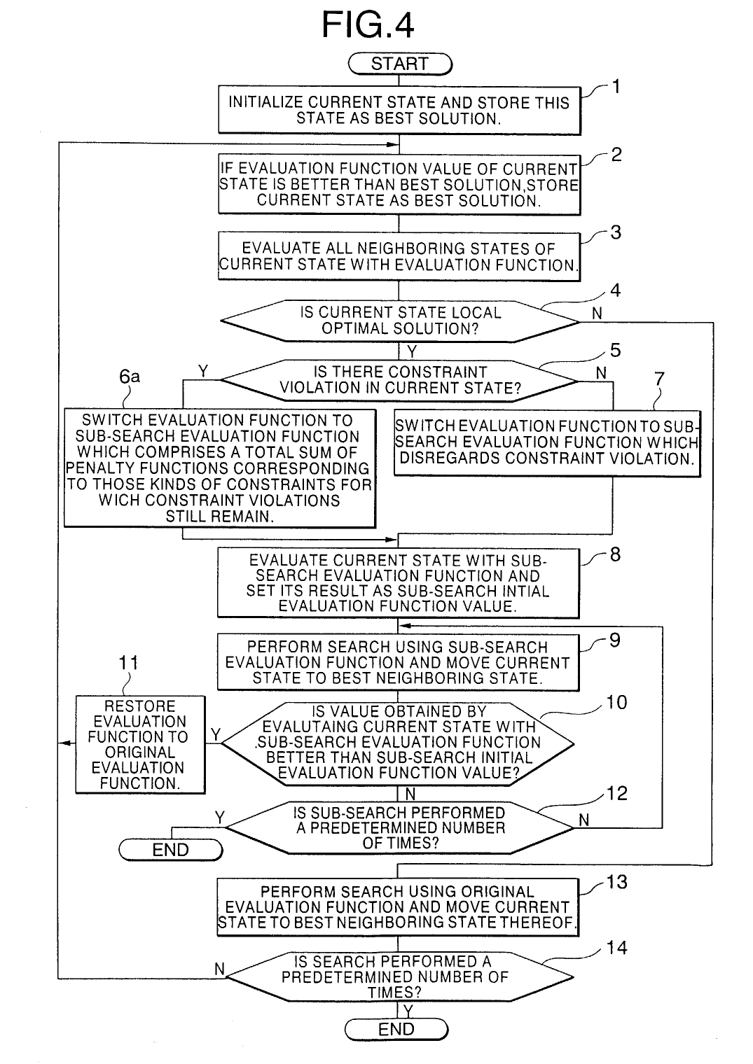

FIG. 4 is a flow chart explaining the operation of an apparatus for optimizing combinatorial optimization problems in accordance with another or second embodiment of the present invention. The same or corresponding parts as those in the above-mentioned embodiment are identified by the same symbols while omitting an explanation thereof. This embodiment is different from the above-mentioned first embodiment in that the processing block or step 6 of FIG. 2 is replaced by a processing block or step 6a. In the processing block 6a of FIG. 4, the evaluation function is switched to a new evaluation function (a sub-search evaluation function) which comprises a total sum of penalty functions corresponding to those types of constraints for which constraint violations still remain.

In this second embodiment, the penalty is classified or subdivided into a plurality of kinds of penalties. In case where one kind of penalty takes place, the operations or moves of the search become the same as those described in the first embodiment. On the other hand, in case where there take place a plurality of kinds of penalties, assuming that the sum of the penalties are taken as one total penalty, the same explanation as made in the first embodiment will hold true for this case.

In the present invention, even when there is intrinsically a relation of conflict between an evaluation function to be minimized or maximized and a penalty, it is possible to find a good solution more efficiently by disregarding one of them under a certain condition. In addition, according to this embodiment, in case where there is a relation of conflict between subdivided penalties, it is possible to find a good solution more efficiently by disregarding one or some of the penalties under a certain condition.

Embodiment 3.

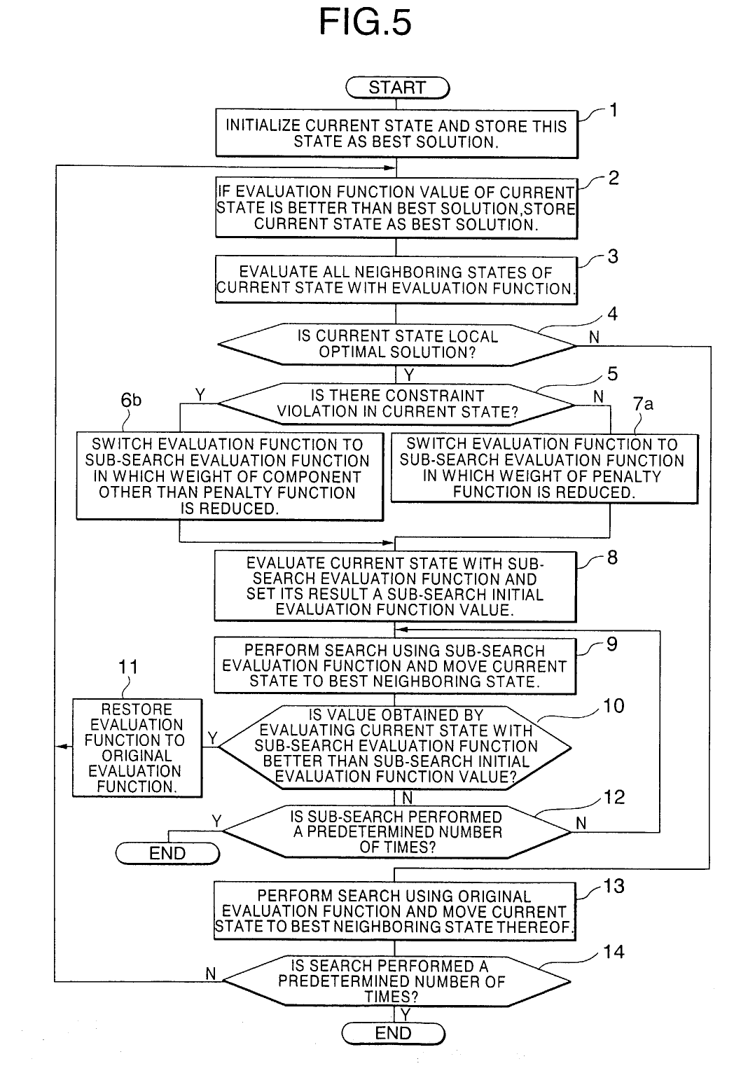

FIG. 5 is a flow chart explaining the operation of an apparatus for optimizing combinatorial optimization problems in accordance with a further or third embodiment of the present invention. The same or corresponding parts as those in the above-mentioned first embodiment are identified by the same symbols while omitting an explanation thereof. This embodiment is different from the first embodiment in that the processing blocks or steps 6 and 7 of FIG. 2 are replaced by processing blocks or steps 6b and 7a, respectively. In the processing block 6b of FIG. 5, the evaluation function is switched to another evaluation function (i.e., a sub-search evaluation function) in which the weight of components other than penalty functions is reduced. In the processing block 7a, the evaluation function is switched to a further evaluation function (i.e., a sub-search evaluation function) in which the weight of the penalty functions is reduced.

This third embodiment is intended to achieve the same effect as that obtained by “disregarding” in the first embodiment, by “reducing weight”, so that a good solution can be found more efficiently by performing weighting through the use of the nature or characteristics of a problem to be solved.

Embodiment 4.

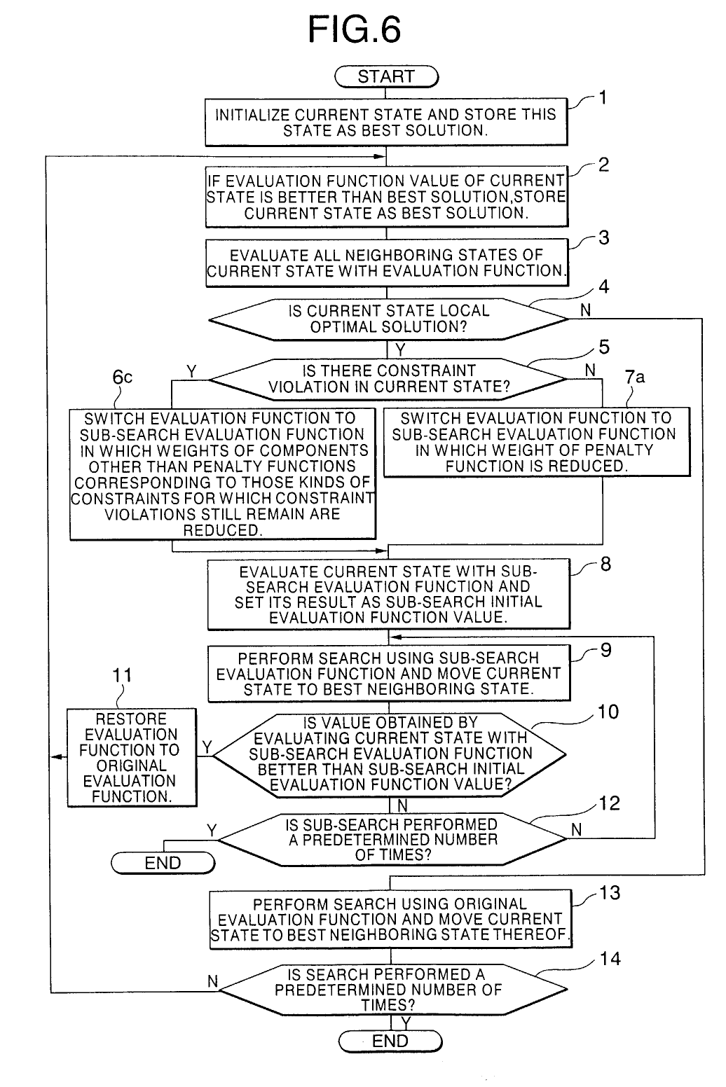

FIG. 6 is a flow chart explaining the operation of an apparatus for optimizing combinatorial optimization problems in accordance with a still further or fourth embodiment of the present invention. The same or corresponding parts as those in the above-mentioned third embodiment are identified by the same symbols while omitting an explanation thereof. This embodiment is different from the third embodiment in that the processing block or step 6b of FIG. 5 is replaced by a processing block or step 6c. In the processing block 6c of FIG. 6, the evaluation function is switched to another evaluation function (i.e., a sub-search evaluation function) in which the weights of components other than penalty functions corresponding to those types of constraints for which constraint violations still remain are reduced.

In this fourth embodiment, too, it is intended to achieve the same effect as that obtained by “disregarding” in the second embodiment, by “reducing weights”, so that a good solution can be found more efficiently by performing weighting through the use of the nature or characteristics of a problem to be solved.

As described in the foregoing, according to a first aspect of the present invention, there is provided an apparatus for optimizing a combinatorial optimization problem by using a computer, in which starting from an initial combination state, a destination state to which a certain state is to be moved is determined from its neighboring states or previously defined transferable combination states by using an evaluation function, and an optimal combination state for minimizing or maximizing the function value of an evaluation function comprising the sum of a function to be minimized or maximized and a penalty function representing an amount of constraint violation is found by iteratively performing a search in which the certain state is successively moved to the thus determined destination state. The apparatus includes: first processing means for switching the evaluation function to another evaluation function which evaluates a constraint violation alone thereby to find a sub-search initial evaluation function value, which is an evaluation function value for a current combination state, when there exists no neighboring state having an evaluation function value better than that of the current combination state, and when there still remains a constraint violation in the current combination state; second processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing; third processing means for switching the evaluation function to another evaluation function which disregards the constraint violation thereby to find a sub-search initial evaluation function value, which is an evaluation function value for the current combination state, when there exists no neighboring state having an evaluation function value better than that of the current combination state, and when there exists no constraint violation in the current combination state; and fourth processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there no longer exists a better solution, thus ending the processing.

In one preferred form of the first aspect of the present invention, in the first processing means, the evaluation function comprises a total sum of a function to be minimized or maximized and a plurality of penalty functions each representing the value of each type of constraint violation, and the evaluation function is switched to a total sum of penalty functions corresponding to those types of constraints for which constraint violations still remain, thereby to find a sub-search initial evaluation function value, which is an evaluation function value for the current combination state, when there exists no neighboring state having an evaluation function value better than that of the current combination state, and when there still remain constraint violations in the current combination state. In the second processing means, a search using the new evaluation function is started in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing.

According to a second aspect of the present invention, there is provided an apparatus for optimizing a combinatorial optimization problem by using a computer, in which starting from an initial combination state, a destination state to which a certain state is to be moved is determined from its neighboring states or previously defined transferable combination states by using an evaluation function, and an optimal combination state for minimizing or maximizing the function value of an evaluation function comprising the sum of a function to be minimized or maximized and a penalty function representing an amount of constraint violation is found by iteratively performing a search in which the certain state is successively moved to the thus determined destination state. The apparatus includes: first processing means for switching the evaluation function to a new evaluation function in which the weights of components other than the penalty function are reduced, thereby to find a sub-search initial evaluation function value, which is an evaluation function value for a current combination state, when there exists no neighboring state having an evaluation function value better than that of the current combination state, and when there still remains a constraint violation in the current combination state; second processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing; third processing means for switching the evaluation function to a new evaluation function in which the weight of the penalty function is reduced, thereby to find a sub-search initial evaluation function value, which is an evaluation function value for the current combination state, when there exists no neighboring state having an evaluation function value better than that of the current combination state, and when there exists no constraint violation in the current combination state; and fourth processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there no longer exists a better solution, thus ending the processing.

In one preferred form of the second aspect of the present invention, in the first processing means, the evaluation function comprises a total sum of a function to be minimized or maximized and a plurality of penalty functions each representing the value of each type of constraint violation, and the evaluation function is switched to a new evaluation function in which the weights of components other than penalty functions corresponding to those types of constraints for which constraint violations still remain are reduced, thereby to find a sub-search initial evaluation function value, which is an evaluation function value for the current combination state, when there exists no neighboring state having an evaluation function value better than that of the current combination state, and when there still remain constraint violations in the current combination state. In the second processing means, a search using the new evaluation function is started in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing.

According to the various aspects of the present invention as referred to above, there are achieved the following advantages. When a local optimal solution is reached in the process of searching, the evaluation function is switched to another evaluation function, so that the value of a penalty function representing the amount of constraint violation can be improved though the value of a function constituting the evaluation function to be minimized or maximized may be increased or decreased, or the value of a function to be minimized or maximized, which constitutes the evaluation function, can be decreased or increased though a constraint violation may take place. Accordingly, it becomes possible for a state to move to its neighboring state, which would be difficult in a search using an original or intrinsic evaluation function, thereby enabling an efficient escape from the neighborhood of a local optimal solution. As a result, the efficiency of the entire search can be improved, thus making it possible to solve combinatorial optimization problems in an efficient manner.

While the invention has been described in terms of preferred embodiments, those skilled in the art will recognize that the invention can be practiced with modifications within the spirit and scope of the appended claims.

What is claimed is:

1. An apparatus for optimizing a combinatorial optimization problem by using a computer, in which starting from an initial combination state, a destination state to which a certain state is to be moved is determined from one of its neighboring states and previously defined transferable combination states by using an evaluation function, and an optimal combination state for minimizing or maximizing the function value of an evaluation function comprising the sum of a function to be minimized or maximized and a penalty function representing an amount of constraint violation is found by iteratively performing a search in which the certain state is successively moved to the thus determined destination state,
said apparatus comprising:
first processing means for switching the evaluation function to another evaluation function which evaluates a constraint violation alone thereby to find a sub-search initial evaluation function value, which is an evaluation function value for a current combination state, when there exists no neighboring state having an evaluation function value better than that of the current combination state, and when there still remains a constraint violation in the current combination state;
second processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing;
third processing means for switching the evaluation function to another evaluation function which disregards the constraint violation thereby to find a sub-search initial evaluation function value, which is an evaluation function value for the current combination state, when there exists no neighboring state having an evaluation function value better than that of the current combination state, and when there exists no constraint violation in the current combination state; and
fourth processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there no longer exists a better solution, thus ending the processing.

2. The combinatorial optimization problem optimizing apparatus according to claim 1, wherein
in said first processing means, the evaluation function comprises a total sum of a function to be minimized or maximized and a plurality of penalty functions each representing the value of each type of constraint violation, and the evaluation function is switched to a total sum of penalty functions corresponding to those types of constraints for which constraint violations still remain, thereby to find a sub-search initial evaluation function value, which is an evaluation function value for the current combination state, when there exists no neighboring state having an evaluation function value better than that of the current combination state, and when there still remain constraint violations in the current combination state; and
in said second processing means, a search using the new evaluation function is started in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing.

3. An apparatus for optimizing a combinatorial optimization problem by using a computer, in which starting from an initial combination state, a destination state to which a certain state is to be moved is determined from one of its neighboring states and previously defined transferable combination states by using an evaluation function, and an optimal combination state for minimizing or maximizing the function value of an evaluation function comprising the sum of a function to be minimized or maximized and a penalty function representing an amount of constraint violation is found by iteratively performing a search in which the certain state is successively moved to the thus determined destination state,
said apparatus comprising:
first processing means for switching the evaluation function to a new evaluation function in which the weight of component other than the penalty function is reduced, thereby to find a sub-search initial evaluation function value, which is an evaluation function value for a current combination state, when there exists no neighboring state having an evaluation function value better than that of the current combination state, and when there still remains a constraint violation in the current combination state;
second processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing;
third processing means for switching the evaluation function to a new evaluation function in which the weight of the penalty function is reduced, thereby to find a sub-search initial evaluation function value, which is an evaluation function value for the current combination state, when there exists no neighboring state having an evaluation function value better than that of the current combination state, and when there exists no constraint violation in the current combination state; and
fourth processing means for starting a search using the new evaluation function in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there no longer exists a better solution, thus ending the processing.

4. The combinatorial optimization problem optimizing apparatus according to claim 3, wherein
in said first processing means, said evaluation function comprises a total sum of a function to be minimized or maximized and a plurality of penalty functions each representing the value of each type of constraint violation, and the evaluation function is switched to a new evaluation function in which the weights of components other than penalty functions corresponding to those types of constraints for which constraint violations still remain are reduced, thereby to find a sub-search initial evaluation function value, which is an evaluation function value for the current combination state, when there exists no neighboring state having an evaluation function value better than that of the current combination state, and when there still remain constraint violations in the current combination state; and
in said second processing means, a search using the new evaluation function is started in such a manner that if a combination state having an evaluation function value better than the sub-search initial evaluation function value is reached within a predetermined number of searches, the search is continued while restoring the evaluation function to the original evaluation function, whereas if a combination state having an evaluation function value better than the sub-search initial evaluation function value is unable to be reached within the predetermined number of searches, it is determined that there exists no feasible solution, thereby ending the processing.
